(19) United States
(12) Patent Application Publication
(10) Pub. No.: US 2022/0135860 A1
(43) Pub. Date: May 5, 2022

(54) HEAT STORAGE MATERIAL COMPOSITION AND HEAT STORAGE APPARATUS

(71) Applicant: PANASONIC CORPORATION, Osaka (JP)

(72) Inventors: Ryuichi OZAKI, Osaka (JP); Tatsuya NAKAMURA, Osaka (JP)

(21) Appl. No.: 17/431,373

(22) PCT Filed: Mar. 6, 2020
(86) PCT No.: PCT/JP2020/009807

§ 371 Date: Aug. 16, 2021

(30) Foreign Application Priority Data
Mar. 14, 2019 (JP) 2019-047121

(51) Int. Cl. C09K 5/10; F28D 20/02

(52) U.S. Cl. CPC C09K 5/10; C09K 2205/108; C09K 2205/102; F28D 20/021

(57) ABSTRACT

Provided is a heat storage material composition that is less likely to vaporize and has a sufficiently stabilized supercooled state. A heat storage material composition according to an aspect of the present disclosure includes sodium acetate, water, and an alcohol. The alcohol includes at least one selected from the group consisting of 1,2-butanediol and a dihydric alcohol having 5 or 6 carbon atoms. The dihydric alcohol is for example a straight-chain alcohol. For example, two hydroxy groups contained in the dihydric alcohol are each bonded to a different one of a carbon atom at a 1-position and a carbon atom at a 2-position contained in the dihydric alcohol. The alcohol includes for example at least one selected from the group consisting of 1,2-butanediol, 1,2-pentanediol, and 1,2-hexanediol.

### TECHNICAL FIELD

The present disclosure relates to a heat storage material composition and a heat storage apparatus.

### BACKGROUND ART

Latent heat storage materials utilizing phase change of melting and solidification of materials have been conventionally known. A latent heat storage material contains for example sodium acetate trihydrate as a main component. Heat storage can be performed using a latent heat storage material by the following method. First, in heat storage, a latent heat storage material is heated to be in a liquid state. Next, the latent heat storage material is cooled. At this time, the latent heat storage material is supercooled to maintain the liquid state. Heat stored in the latent heat storage material can be extracted by crystallizing the latent heat storage material, when needed.

Patent Literatures 1 and 2 disclose heat storage material compositions containing alcohols.

### CITATION LIST

### Patent Literatures

Patent Literature 1: JP 2015-183973 A

Patent Literature 2: JP 2016-20470 A

### SUMMARY OF INVENTION

Of the alcohols disclosed in Patent Literatures 1 and 2, monohydric alcohols have an insufficiently high boiling point and accordingly may vaporize during heat storage of the heat storage material compositions. Of the alcohols disclosed in Patent Literatures 1 and 2, polyhydric alcohols having two or more hydroxy groups cannot sufficiently stabilize the supercooled state of the heat storage material compositions.

The present disclosure provides a heat storage material composition that is less likely to vaporize and has a sufficiently stabilized supercooled state.

A heat storage material composition according to one aspect of the present disclosure includes sodium acetate, water, and an alcohol. The alcohol includes at least one selected from the group consisting of 1,2-butanediol and a dihydric alcohol having 5 or 6 carbon atoms.

According to the present disclosure, it is possible to provide a heat storage material composition that is less likely to vaporize and has a sufficiently stabilized supercooled state.

### BRIEF DESCRIPTION OF DRAWINGS

FIG. 1 is a triangular diagram showing a mass ratio between three components including sodium acetate, water, and 1,2-butanediol in a heat storage material composition according to an embodiment of the present disclosure.

FIG. 2 is a triangular diagram showing a mass ratio between three components including sodium acetate, water, and 1,2-pentanediol in a heat storage material composition according to a modification of the present disclosure.

FIG. 3 is a triangular diagram showing a mass ratio between three components including sodium acetate, water, and 1,2-hexanediol in a heat storage material composition according to another modification of the present disclosure.

FIG. 4 is a schematic cross-sectional view of a heat storage apparatus using the heat storage material composition of the present disclosure.

### DESCRIPTION OF EMBODIMENTS

(Findings on which the Present Disclosure is Based)

Of the alcohols disclosed in Patent Literatures 1 and 2, the monohydric alcohols have an insufficiently high boiling point. Accordingly, when the heat storage material compositions of Patent Literatures 1 and 2 are heated to a high temperature of 97° C. or more and 150° C. or less for example, the monohydric alcohols contained in the heat storage material compositions may vaporize. This may increase an internal pressure of a heat storage apparatus housing the heat storage material compositions thus to damage the heat storage apparatus. At this time, the heat storage material compositions in the liquid state may leak from the heat storage apparatus. Further, vaporization of the monohydric alcohols may change the composition of the heat storage material compositions.

A heat storage material composition according to a first aspect of the present disclosure includes sodium acetate, water, and an alcohol. The alcohol includes 1,2-butanediol, a dihydric alcohol having 5 carbon atoms, or a dihydric alcohol having 6 carbon atoms.

According to the first aspect, the alcohol includes 1,2-butanediol, a dihydric alcohol having 5 carbon atoms, or a dihydric alcohol having 6 carbon atoms. This alcohol has a sufficiently high boiling point and accordingly is less likely to vaporize. Further, this alcohol can sufficiently stabilize a supercooled state of the heat storage material composition.

In a second aspect of the present disclosure, for example in the heat storage material composition according to the first aspect, the dihydric alcohols may be straight-chain alcohols. According to the second aspect, the supercooled state of the heat storage material composition is further stabilized.

In a third aspect of the present disclosure, for example in the heat storage material composition according to the first or second aspect, two hydroxy groups contained in each of the dihydric alcohols each may be bonded to a different one of a carbon atom at a 1-position and a carbon atom at a 2-position contained in the dihydric alcohol. According to the third aspect, the supercooled state of the heat storage material composition is further stabilized.

In a fourth aspect of the present disclosure, for example in the heat storage material composition according to any one of the first to third aspects, the alcohol may dissolve in water at 20° C. at a rate of 1 kg or more per litter. According to the fourth aspect, repetition of heat storage and heat radiation on the heat storage material composition is less likely to separate the water and the alcohol in the heat storage material composition. Thus, a long-term use of the heat storage material composition is less likely to change the composition of the heat storage material composition.

In a fifth aspect of the present disclosure, for example in the heat storage material composition according to any one of the first to fourth aspects, the alcohol may include 1,2-butanediol, 1,2-p entanediol, or 1,2-hexanediol. According to the fifth aspect, in the alcohol, the hydroxy groups function as hydrophilic groups, and a carbon chain that is not bonded to any hydroxy group functions as a hydrophobic group. According to this alcohol, an interaction between the sodium acetate, the water, and the alcohol further suppresses crystallization of the sodium acetate. Thus, the supercooled state of the heat storage material composition is further stabilized.

In a sixth aspect of the present disclosure, for example in the heat storage material composition according to any one of the first to fifth aspects, a ratio of a mass of the sodium acetate to a total mass of the sodium acetate, the water, and the alcohol may be 20 wt % or more. According to the sixth aspect, the heat storage material composition is easily supercooled. Here, the term wt % represents mass %.

In a seventh aspect of the present disclosure, for example in the heat storage material composition according to any one of the first to sixth aspects, the alcohol may be 1,2-butanediol. When mass ratios of three components including the sodium acetate, the water, and the alcohol are respectively represented as x, y, and z (where x+y+z=100), in a triangular diagram showing a mass ratio between the three components (x:y:z), the mass ratio between the three components may fall within the following range. That is, the mass ratio may fall within a range surrounded by a straight line connecting a point A (20:79.9:0.1) and a point B (50:49.5:0.5), a straight line connecting the point B and a point C (52:46:2), a straight line connecting the point C and a point D (80:18:2), a straight line connecting the point D and a point E (80:10:10), a straight line connecting the point E and a point F (20:5:75), and a straight line connecting the point F and the point A. According to the seventh aspect, the supercooled state of the heat storage material composition is further stabilized.

In an eighth aspect of the present disclosure, for example in the heat storage material composition according to any one of the first to sixth aspects, the alcohol may be 1,2-pentanediol. When mass ratios of three components including the sodium acetate, the water, and the alcohol are respectively represented as x, y, and z (where x+y+z=100), in a triangular diagram showing a mass ratio between the three components (x:y:z), the mass ratio between the three components may fall within the following range. That is, the mass ratio may fall within a range surrounded by a straight line connecting a point A (20:79.9:0.1) and a point B (60:39.5:0.5), a straight line connecting the point B and a point C (80:18:2), a straight line connecting the point C and a point D (80:5:15), a straight line connecting the point D and a point E (20:5:75), and a straight line connecting the point E and the point A. According to the eighth aspect, the supercooled state of the heat storage material composition is further stabilized.

In a ninth aspect of the present disclosure, for example in the heat storage material composition according to any one of the first to sixth aspects, the alcohol may be 1,2-hexanediol. When mass ratios of three components including the sodium acetate, the water, and the alcohol are respectively represented as x, y, and z (where x+y+z=100), in a triangular diagram showing a mass ratio between the three components (x:y:z), the mass ratio between the three components may fall within the following range. That is, the mass ratio may fall within a range surrounded by a straight line connecting a point A (20:79.9:0.1) and a point B (60:39.5:0.5), a straight line connecting the point B and a point C (80:18:2), a straight line connecting the point C and a point D (90:8:2), a straight line connecting the point D and a point E (90:5:5), a straight line connecting the point E and a point F (20:5:75), and a straight line connecting the point F and the point A. According to the ninth aspect, the supercooled state of the heat storage material composition is further stabilized.

A heat storage apparatus according to a tenth aspect of the present disclosure includes: the heat storage material composition according to any one of the first to ninth aspects; a container housing the heat storage material composition; and a supercooling release mechanism configured to release a supercooled state of the heat storage material composition.

According to the tenth aspect, the heat storage material composition is less likely to vaporize, and accordingly a pressure inside the container is less likely to increase. Thus, the heat storage apparatus is less likely to be damaged and this reduces a possibility of leakage of the heat storage material composition in the liquid state. In the heat storage apparatus, the supercooled state of the heat storage material composition is stabilized.

Hereinafter, an embodiment of the present disclosure will be described with reference to the drawings. The present disclosure is not limited to the following embodiment.

(Heat Storage Material Composition)

A heat storage material composition of the present embodiment includes sodium acetate, water, and an alcohol. The heat storage material composition may consist of the sodium acetate, the water, and the alcohol. The sodium acetate is for example hydrated by the water contained in the heat storage material composition. In other words, the heat storage material composition may include sodium acetate trihydrate formed by the sodium acetate and the water. The heat storage material composition may include sodium acetate anhydride.

The alcohol contained in the heat storage material composition includes at least one selected from the group consisting of 1,2-butanediol and a dihydric alcohol having 5 or 6 carbon atoms. In the present specification, “an alcohol including at least one selected from the group consisting of 1,2-butanediol and a dihydric alcohol having 5 or 6 carbon atoms” is referred to also as “an alcohol A”, and “a dihydric alcohol having 5 or 6 carbon atoms” is referred to also as “a dihydric alcohol B”. A dihydric alcohol means a hydrocarbon compound having two substituted hydroxy groups. A dihydric alcohol B is for example a saturated hydrocarbon compound having two substituted hydroxy groups.

The dihydric alcohol B is for example a straight-chain alcohol. In the present specification, “a straight-chain alcohol” means that a carbon chain of a dihydric alcohol B is a straight chain. However, the carbon chain of the dihydric alcohol B may be a branched chain.

In the dihydric alcohol B, a position of a carbon atom to which two hydroxy groups are each bonded is not particularly limited. The two hydroxy groups contained in the dihydric alcohol B each may be bonded to a different one of a carbon atom at a 1-position and a carbon atom at a 2-position contained in the dihydric alcohol B.

The dihydric alcohol B is for example 1,2-pentanediol or 1,2-hexanediol. In other words, the alcohol A for example contains at least one selected from the group consisting of 1,2-butanediol, 1,2-pentanediol, and 1,2-hexanediol. These 1,2-butanediol, 1,2-pentanediol, and 1,2-hexanediol are represented by the following formula (1), where n is an integer from 1 to 3 in the formula (1).

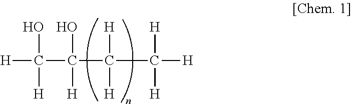

For example, the alcohol A dissolves in water at 20° C. at a rate of 1 kg or more per litter (L). In other words, the alcohol A may be miscible with water. All compounds of the formula (1) are each miscible with water.

The alcohol A may have a boiling point of 150° C. or more, 190° C. or more, 200° C. or more, or 210° C. or more. The upper limit for the boiling point of the alcohol A is not particularly limited, and is for example 240° C. As an example, 1,2-butanediol has a boiling point of 194° C., 1,2-pentanediol has a boiling point of 210° C., and 1,2-hexanediol has a boiling point of 224° C.

The alcohol A when heated to 150° C. may have a saturated vapor pressure of 30 kPa or less, 20 kPa or less, or 10 kPa or less. The lower limit for the saturated vapor pressure of the alcohol A in this case is not particularly limited, and is for example 1 kPa. As an example,1,2-butanediol when heated to 150° C. has a saturated vapor pressure of 26.2 kPa, 1,2-pentanediol when heated to 150° C. has a saturated vapor pressure of 14.2 kPa, and 1,2-hexanediol when heated to 150° C. has a saturated vapor pressure of 8.3 kPa.

A ratio of a mass of the sodium acetate to the total mass W of the sodium acetate, the water, and the alcohol A may be 20 wt % or more. The ratio of the mass of the sodium acetate to the total mass W may be 90 wt % or less. A ratio of a mass of the water to the total mass W may be for example 5 wt % or more and 79.9 wt % or less. A ratio of a mass of the alcohol A to the total mass W may be for example 0.1 wt % or more and 75 wt % or less.

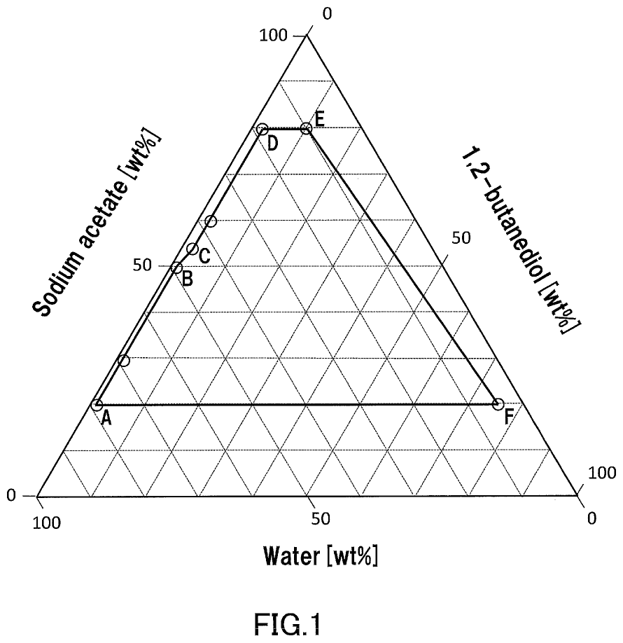

In the heat storage material composition according to the present embodiment, the alcohol A is for example 1,2-butanediol. FIG. 1 is a triangular diagram showing a mass ratio between the three components including the sodium acetate, the water, and the alcohol A in the heat storage material composition. As shown in FIG. 1, the mass ratio between these three components may fall within a range surrounded by a straight line connecting a point A (20:79.9:0.1) and a point B (50:49.5:0.5), a straight line connecting the point B and a point C (52:46:2), a straight line connecting the point C and a point D (80:18:2), a straight line connecting the point D and a point E (80:10:10), a straight line connecting the point E and a point F (20:5:75), and a straight line connecting the point F and the point A. Here, in coordinates of the mass ratio between the three components (x:y:z), x represents the ratio of the mass of the sodium acetate to the total mass W, y represents the ratio of the mass of the water to the total mass W, and z represents the ratio of the mass of the alcohol A to the total mass W. Note that x+y+z=100.

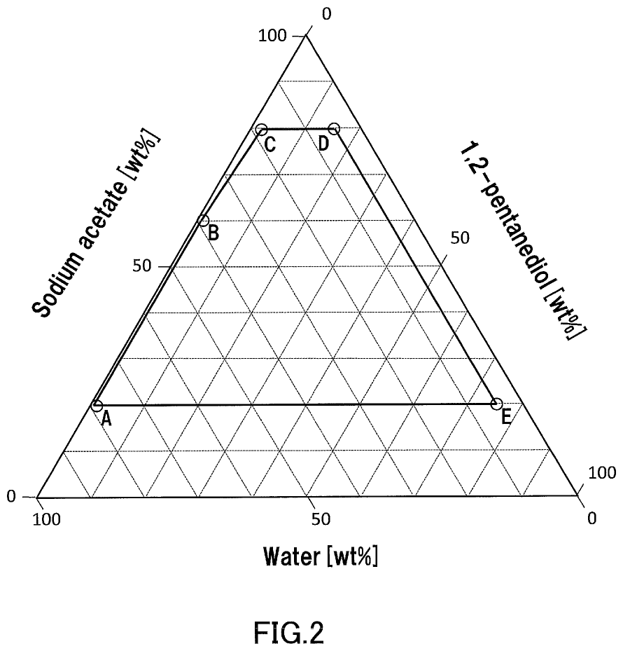

In a heat storage material composition according to a modification, an alcohol A is for example 1,2-pentanediol. FIG. 2 is a triangular diagram showing a mass ratio between three components including sodium acetate, water, and the alcohol A in the heat storage material composition. As shown in FIG. 2, the mass ratio between these three components may fall within a range surrounded by a line connecting a point A (20:79.9:0.1) and a point B (60:39.5:0.5), a line connecting the point B and a point C (80:18:2), a line connecting the point C and a point D (80:5:15), a line connecting the point D and a point E (20:5:75), and a line connecting the point E and the point A.

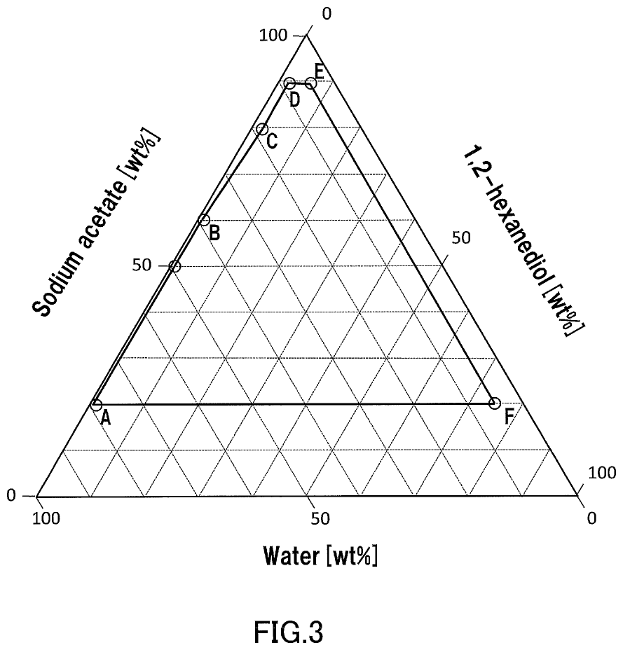

In a heat storage material composition according to another modification, an alcohol A is for example 1,2-hexanediol. FIG. 3 is a triangular diagram showing a mass ratio between three components including sodium acetate, water, and the alcohol A in the heat storage material composition. As shown in FIG. 3, the mass ratio between these three components may fall within a range surrounded by a line connecting a point A (20:79.9:0.1) and a point B (60:39.5:0.5), a line connecting the point B and a point C (80:18:2), a line connecting the point C and a point D (90:8:2), a line connecting the point D and a point E (90:5:5), a line connecting the point E and a point F (20:5:75), and a line connecting the point F and the point A.

The alcohol A has a sufficiently high boiling point and accordingly is less likely to vaporize. Thus, when heat storage is performed on the heat storage material composition, an internal pressure of the heat storage apparatus housing the heat storage material composition is less likely to increase. This reduces a possibility that an increase in internal pressure of the heat storage apparatus damages the heat storage apparatus to cause leakage of the heat storage material composition in the liquid state. Further, since the alcohol A is less likely to vaporize, repetition of heat storage and heat radiation on the heat storage material composition of the present embodiment is less likely to change the composition of the heat storage material composition. Thus, the heat storage material composition of the present embodiment is suitable for long-term use.

The alcohol A also can sufficiently stabilize the supercooled state of the heat storage material composition. In particular, in the compounds of the above formula (1), the hydroxy groups function as hydrophilic groups, and the carbon chain that is not bonded to any hydroxy group functions as a hydrophobic group. An interaction between the sodium acetate, the water, and the compounds of the formula (1) further suppresses crystallization of the sodium acetate. Thus, the supercooled state of the heat storage material composition is further stabilized.

(Heat Storage Apparatus)

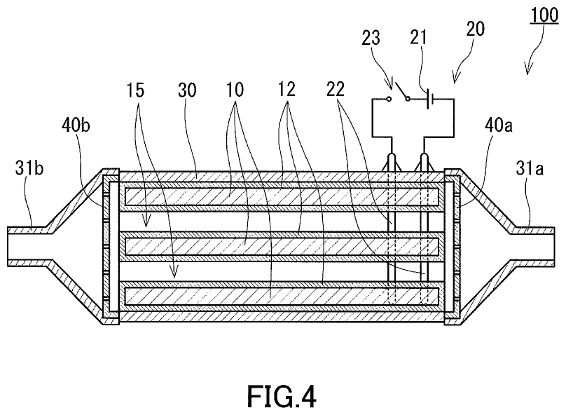

FIG. 4 is a schematic cross-sectional view of the heat storage apparatus 100 of the present embodiment. As shown in FIG. 4, the heat storage apparatus 100 includes heat storage material compositions 10 described above, containers 12, and a supercooling release mechanism 20. The containers 12 house the heat storage material compositions 10. The containers 12 are made of a material having heat transfer properties. The supercooling release mechanism 20 includes a power source 21, a pair of electrodes 22, and a switch 23. The power source 21 may be a DC power source or an AC power source. The pair of electrodes 22 are each electrically connected to the power source 21 by wiring. The pair of electrodes 22 are disposed so as to be in contact with the heat storage material compositions 10. The switch 23 is disposed between one of the pair of electrodes 22 and the power source 21. A voltage can be applied to the pair of electrodes 22 by closing the switch 23.

As shown in FIG. 4, the heat storage apparatus 100 for example further includes a central housing 30, an end member 31a, an end member 31b, a rectifying member 40a, and a rectifying member 40b. The central housing 30 is a tubular housing made of a material having heat insulation properties. In an inner space of the central housing 30, the containers 12 housing the heat storage material compositions 10 are disposed. In the inner space of the central housing 30, heating medium flow paths 15 are formed by outer peripheral surfaces of the containers 12 and an inner peripheral surface of the central housing 30. The heating medium flow paths 15 are flow paths of a heating medium for imparting heat to the heat storage material compositions 10 or a heating medium for recovering heat from the heat storage material compositions 10. The end member 31a is fixed to one end of the central housing 30, and the end member 31b is fixed to the other end of the central housing 30. Each of the end member 31a and the end member 31b is a funnel-shaped member, and forms a space expanding toward the central housing 30. An inlet or an outlet of the heating medium is formed by each of the end member 31a and the end member 31b. Also, the rectifying member 40a is fixed to the inside of the end member 31a at one end of the central housing 30, and the rectifying member 40b is fixed to the inside of the end member 31b at the other end of the central housing 30. The rectifying member 40a and the rectifying member 40b are each a plate-shaped member having through holes, and function to rectify the flow of the heating medium.

Next, a heat storage method using the heat storage apparatus 100 will be described.

First, the heat storage material compositions 10 are heated by a heating medium. When the temperature of the heat storage material compositions 10 exceeds a melting point of the heat storage material compositions 10, the heat storage material compositions 10 melt. Next, the heat storage material compositions 10 are cooled. As a result, the temperature of the heat storage material compositions 10 falls below the melting point of the heat storage material compositions 10, and thus the heat storage material compositions 10 are supercooled.

Next, a voltage is applied to the pair of electrodes 22. This applies an electrical stimulation to the heat storage material compositions 10 to change the heat storage material compositions 10 from a liquid state to a solid state. As a result, the heat stored in the heat storage material compositions 10 is emitted.

In the heat storage apparatus 100, the supercooling release mechanism 20 is not limited to the above-described configuration. The supercooling release mechanism 20 may be a plate member having a groove. In this case, the supercooling release mechanism 20 is housed in the containers 12, for example. The plate member is made of for example a metal or a resin and has elasticity. When a stress is applied to the plate member to deform the plate member such that an opening of the groove increases in size, the supercooled state of the heat storage material compositions 10 is released. The heat storage material compositions 10 thus can be changed from the liquid state to the solid state.

### EXAMPLES

The present disclosure will be specifically described based on examples, but the present disclosure is not limited in any way by the following examples.

### Comparative Example 1

First, 29.7 g of sodium acetate and 22.6 g of water were mixed. Next, the obtained mixture was heated in a thermostatic chamber at 90° C. to dissolve the sodium acetate in the water. Then, a temperature of the obtained solution was decreased to a room temperature. In the present specification, the room temperature is 20±15° C. Then, crystals of sodium acetate trihydrate were added to the solution. This resulted in crystallization of the solution to obtain a heat storage material composition of Comparative Example 1.

### Comparative Examples 2 to 4 and Examples 1 to 3

Heat storage material compositions of Comparative Examples 2 to 4 and Examples 1 to 3 were obtained by the same method as that in Comparative Example 1, except that 3.7 g of a stabilizer described in Table 1 was further mixed with sodium acetate and water. A solution that did not crystallize by addition of sodium acetate trihydrate crystals was cooled in a thermostatic chamber at −45° C. for crystallization.

[Stability Evaluation of Supercooled State]

Next, stability evaluation of the supercooled state was performed by the following method on each of the heat storage material compositions of Comparative Examples 1 to 4 and Examples 1 to 3. First, the heat storage material composition was housed in a sample bottle made of glass, and the sample bottle was sealed. A thermocouple was attached to the sample bottle with an electrically-conductive tape. Next, the sample bottle was placed in the thermostatic chamber. The temperature of the thermostatic chamber was set at 30° C. After confirmation that the temperature of the heat storage material composition was about 30° C., the temperature of the thermostatic chamber was increased to 65° C. at a temperature increase rate of 2° C./min. Then, the temperature of the thermostatic chamber was maintained at 65° C. for 3.5 hours. The heat storage material composition thus melted. Next, the temperature of the thermostatic chamber was decreased to −20° C. at a temperature decrease rate of 2° C./min. The temperature of the thermostatic chamber was maintained at −20° C. for 12 hours. At this time, observation was performed as to whether the heat storage material composition crystallized or not. With respect to the crystallized heat storage material composition, a period from when the temperature of the thermostatic chamber reached −20° C. till the heat storage material composition crystallized was recorded. This period was regarded as a period during which the supercooled state of the heat storage material composition was maintained. Next, with respect to the heat storage material composition that did not crystallize in the above-mentioned operation, the temperature of the thermostatic chamber was decreased to −45° C. and was maintained at −45° C. for 3 hours to crystallize the heat storage material composition. Next, the temperature of the thermostatic chamber was increased to 30° C. at a temperature increase rate of 2° C./min. The above operation relevant to the temperature of the thermostatic chamber was defined as one cycle, and this cycle was repeated six times to perform the stability evaluation of the supercooled state of the heat storage material composition. In the stability evaluation, the sum of the periods during which the supercooled state of the heat storage material composition was maintained at −20° C. was divided by the number of the cycles to calculate an average value of the periods during which the supercooled state was maintained. Further, the number of times the supercooled state of the heat storage material composition was maintained at −20° C. for 12 hours was divided by the number of the cycles to calculate a probability that the supercooled state was maintained for 12 hours.

The results are shown in Table 1.

TABLE 1

| | | Average value | | The number of times |
|---|---|---|---|---|
| | | of periods during | Probability that | supercooled state |
| | | which supercooled | supercooled state | was maintained for |
| | Supercooling | state was | was maintained for | 12 hours/the number |
| | stabilizer | maintained (h) | 12 hours (%) | of cycles |
| Comparative | — | 0 | 0 | 0/6 |
| Example 1 | | | | |
| Comparative | Ethylene glycol | 0 | 0 | 0/6 |
| Example 2 | | | | |
| Comparative | Propylene | 3.4 | 16.7 | 1/6 |
| Example 3 | glycol | | | |
| Example 1 | 1,2-butanediol | 12.0 | 100 | 6/6 |
| Comparative | 1,3-butanediol | 10.9 | 66.7 | 4/6 |
| Example 4 | | | | |
| Example 2 | 1,2-pentanediol | 12.0 | 100 | 6/6 |
| Example 3 | 1,2-hexanediol | 12.0 | 100 | 6/6 |

As can be seen from Table 1, the heat storage material composition of Comparative Example 1, which contained no stabilizer, and the heat storage material compositions of Comparative Examples 1 to 4, which contained alcohols different from the alcohol A, could not sufficiently maintain the supercooled state and exhibited a poor stability of the supercooled state. Compared with this, the heat storage material compositions of Examples 1 to 3, which contained the alcohol A, did not crystallized at −20° C. and exhibited an excellent stability of the supercooled state.

### Examples 4 to 11

Heat storage material compositions of Examples 4 to 11 were obtained by the same method as that in Example 1, except that an addition amount of three components including sodium acetate, water, and 1,2-butanediol was adjusted such that a mass ratio between the three components had values described in Table 2. Further, the stability evaluation of the supercooled state was performed on these heat storage material compositions by the same method as that in Example 1, except that the temperature of the thermostatic chamber during heat storage was changed from 65° C. to 75° C. and the number of the cycles was changed from six to four. The results are shown in Table 2.

TABLE 2

| | | | | Average value of | Probability that |
|---|---|---|---|---|---|
| | Mass ratio (wt %) | | | periods during which | supercooled state |
| | Sodium | | 1,2- | supercooled state | was maintained |
| Example | acetate | Water | butanediol | was maintained (h) | for 12 hours (%) |
| 4 | 20 | 79.9 | 0.1 | 12 | 100 |
| 5 | 20 | 5 | 75 | 12 | 100 |
| 6 | 30 | 69.9 | 0.1 | 12 | 100 |
| 7 | 50 | 49.5 | 0.5 | 12 | 100 |
| 8 | 52 | 46 | 2 | 12 | 100 |
| 9 | 60 | 38 | 2 | 12 | 100 |
| 10 | 80 | 18 | 2 | 12 | 100 |
| 11 | 80 | 10 | 10 | 12 | 100 |

The mass ratio between the three components in Examples 4 to 11 corresponds to circles (∘) in FIG. 1. As can be seen from Table 2 and FIG. 1, when the mass ratio between the three components including sodium acetate, water, and 1,2-butanediol falls within a range surrounded by a frame in FIG. 1, the supercooled state of the heat storage material composition is sufficiently stabilized.

### Examples 12 to 17

Heat storage material compositions of Examples 12 to 17 were obtained by the same method as that in Example 2, except that an addition amount of three components including sodium acetate, water, and 1,2-pentanediol was adjusted such that a mass ratio between the three components had values described in Table 3. Further, the stability evaluation of the supercooled state was performed on these heat storage material compositions by the same method as that in Example 4. The results are shown in Table 3.

TABLE 3

| | | | | Average value of | Probability that |
|---|---|---|---|---|---|
| | Mass ratio (wt %) | | | periods during which | supercooled state |
| | Sodium | | 1,2- | supercooled state | was maintained |
| Example | acetate | Water | pentanediol | was maintained (h) | for 12 hours (%) |
| 12 | 20 | 79.9 | 0.1 | 12 | 100 |
| 13 | 20 | 5 | 75 | 12 | 100 |
| 14 | 60 | 39.5 | 0.5 | 12 | 100 |
| 15 | 60 | 38 | 2 | 12 | 100 |
| 16 | 80 | 18 | 2 | 12 | 100 |
| 17 | 80 | 5 | 15 | 12 | 100 |

The mass ratio between the three components in Examples 12 to 17 corresponds to circles (∘) in FIG. 2. As can be seen from Table 3 and FIG. 2, when the mass ratio between the three components including sodium acetate, water, and 1,2-pentanediol falls within a range surrounded by a frame in FIG. 2, the supercooled state of the heat storage material composition is sufficiently stabilized.

### Examples 18 to 25

Heat storage material compositions of Examples 18 to 25 were obtained by the same method as that in Example 3, except that an addition amount of three components including sodium acetate, water, and 1,2-hexanediol was adjusted such that the mass ratio between the three components had values described in Table 3. The stability evaluation of the supercooled state was performed on these heat storage material compositions by the same method as that in Example 4. The results are shown in Table 4.

TABLE 4

| | | | | Average value of | Probability that |
|---|---|---|---|---|---|
| | Mass ratio (wt %) | | | periods during which | supercooled state |
| | Sodium | | 1,2- | supercooled state | was maintained |
| Example | acetate | Water | hexanediol | was maintained (h) | for 12 hours (%) |
| 18 | 20 | 79.9 | 0.1 | 12 | 100 |
| 19 | 20 | 5 | 75 | 12 | 100 |
| 20 | 50 | 49.5 | 0.5 | 12 | 100 |
| 21 | 60 | 39.5 | 0.5 | 12 | 100 |
| 22 | 60 | 38 | 2 | 12 | 100 |
| 23 | 80 | 18 | 2 | 12 | 100 |
| 24 | 90 | 8 | 2 | 12 | 100 |
| 25 | 90 | 5 | 5 | 12 | 100 |

The mass ratio between the three components in Examples 18 to 25 corresponds to circles (∘) in FIG. 3. As can be seen from Table 4 and FIG. 3, when the mass ratio between the three components including sodium acetate, water, and 1,2-hexanediol falls within a range surrounded by a frame in FIG. 3, the supercooled state of the heat storage material composition is sufficiently stabilized.

### INDUSTRIAL APPLICABILITY

The heat storage material composition and the heat storage apparatus of the present disclosure are suitable for warming up apparatuses by using waste heat of an internal combustion engine, waste heat of a combustion boiler, and the like as a heat source. The techniques disclosed herein are also applicable to air conditioners, water heaters, battery cooling systems for electric vehicles (EVs), and residential floor heating systems.

### REFERENCE SIGNS LIST

10 heat storage material composition

12 container

20 supercooling release mechanism

100 heat storage apparatus

1. A heat storage material composition comprising:
sodium acetate;
water; and
an alcohol, wherein
the alcohol includes 1,2-butanediol, a dihydric alcohol having 5 carbon atoms, or a dihydric alcohol having 6 carbon atoms.

2. The heat storage material composition according to claim 1, wherein the dihydric alcohols are straight-chain alcohols.

3. The heat storage material composition according to claim 1, wherein
two hydroxy groups contained in each of the dihydric alcohols are each bonded to a different one of a carbon atom at a 1-position and a carbon atom at a 2-position contained in the dihydric alcohol.

4. The heat storage material composition according to claim 1, wherein
the alcohol dissolves in water at 20° C. at a rate of 1 kg or more per litter.

5. The heat storage material composition according to claim 1, wherein
the alcohol includes 1,2-butanediol, 1,2-pentanediol, or 1,2-hexanediol.

6. The heat storage material composition according to claim 1, wherein
a ratio of a mass of the sodium acetate to a total mass of the sodium acetate, the water, and the alcohol is 20 wt % or more.

7. The heat storage material composition according to claim 1, wherein
the alcohol is 1,2-butanediol, and
when mass ratios of three components including the sodium acetate, the water, and the alcohol are respectively represented as x, y, and z (where x+y+z=100),
in a triangular diagram showing a mass ratio between the three components (x:y:z), the mass ratio between the three components falls within a range surrounded by a straight line connecting a point A (20:79.9:0.1) and a point B (50:49.5:0.5), a straight line connecting the point B and a point C (52:46:2), a straight line connecting the point C and a point D (80:18:2), a straight line connecting the point D and a point E (80:10:10), a straight line connecting the point E and a point F (20:5:75), and a straight line connecting the point F and the point A.

8. The heat storage material composition according to claim 1, wherein
the alcohol is 1,2-pentanediol, and
when mass ratios of three components including the sodium acetate, the water, and the alcohol are respectively represented as x, y, and z (where x+y+z=100),
in a triangular diagram showing a mass ratio between the three components (x:y:z), the mass ratio between the three components falls within a range surrounded by a straight line connecting a point A (20:79.9:0.1) and a point B (60:39.5:0.5), a straight line connecting the point B and a point C (80:18:2), a straight line connecting the point C and a point D (80:5:15), a straight line connecting the point D and a point E (20:5:75), and a straight line connecting the point E and the point A.

9. The heat storage material composition according to claim 1, wherein
the alcohol is 1,2-hexanediol, and
when mass ratios of three components including the sodium acetate, the water, and the alcohol are respectively represented as x, y, and z (where x+y+z=100),
in a triangular diagram showing a mass ratio between the three components (x:y:z), the mass ratio between the three components falls within a range surrounded by a straight line connecting a point A (20:79.9:0.1) and a point B (60:39.5:0.5), a straight line connecting the point B and a point C (80:18:2), a straight line connecting the point C and a point D (90:8:2), a straight line connecting the point D and a point E (90:5:5), a straight line connecting the point E and a point F (20:5:75), and a straight line connecting the point F and the point A.

10. A heat storage apparatus comprising:
the heat storage material composition according to claim 1;
a container housing the heat storage material composition; and
a supercooling release mechanism configured to release a supercooled state of the heat storage material composition.
